(19) United States
(12) Patent Application Publication
(10) Pub. No.: US 2016/0005268 A1
(43) Pub. Date: Jan. 7, 2016

(54) WAGERING GAME AND METHOD AND SYSTEM FOR INCORPORATING PLAYER ADVANTAGES INTO A WAGERING GAME

(71) Applicants: Robert L. Bronston, Bloomfield, MI (US); Erik W. Scharf, Miami, FL (US)

(72) Inventors: Robert L. Bronston, Bloomfield, MI (US); Erik W. Scharf, Miami, FL (US)

(21) Appl. No.: 14/789,390

(22) Filed: Jul. 1, 2015

Related U.S. Application Data
(60) Provisional application No. 62/020,364, filed on Jul. 2, 2014.

(51) Int. Cl. G07F 17/32

(52) U.S. Cl. CPC G07F 17/3225

(57) ABSTRACT

A game, a system and a method of operating a wagering game is disclosed. In particular, a player may earn, through the play of the game, game assets giving the player the power to affect the rules of play in a desirable way.

### TECHNICAL FIELD AND BACKGROUND

The present disclosure relates generally to the field of gaming, including, systems and methods for implementing wagering games. Gaming devices and table gaming systems provide a great deal of entertainment to both the active players and to those who watch the active play. Such devices and types of game play are present at entertainment venues, at restaurants and bars, and as in-home entertainment.

### SUMMARY

In one aspect, the disclosure provides a computer-implemented method for operating a wagering game. The method of operation comprises receiving, at a processor, a player's first wager for a first game. Next, a set of plays for the first game is displayed on a user interface. The processor then determines whether the player has acquired a first game asset. If the player has acquired a first game asset, the processor next updates a gaming game profile for the player, wherein the game profile for the player comprises a record of the player's current game assets. After, the method includes receiving, by the processor, a first play in the first game according to a set of rules for the first game, wherein the set of rules for the first game is based on the record of the player's current game assets.

In another aspect the disclosure provides a system for operating an electronic wagering game comprising a user interface for displaying a wagering game, an input device for receiving plays from a player, and a memory containing wagering game instructions. The system further comprises a processor coupled to the graphical user interface, the input device, and the memory, which is configured to execute the wagering game instructions. According to the disclosure, the wagering game instructions include receiving a wager input into the input device by a player and then displaying to the user interface, a set of plays for a first game. Further, the instructions include receiving instructions input into the input device by the player regarding applying a game asset to the set of plays for the first game. Next, the instructions include adjusting the set of plays for the first game based on the game asset applied to the set of plays for the first game, and adjusting a game profile for the player based on the game asset having been applied to the set of plays for the first game.

In another aspect, the disclosure provides a non-transitory computer-readable medium comprising computer-readable instructions for performing steps in a wagering game. The steps include receiving, from an input device, a wager. Next, the steps include displaying, to a user interface, a set of plays for a first game. The steps further include receiving, from the input device, instructions for applying a game asset to the set of plays for the first game. Next, the steps include displaying, to a user interface, an adjusted set of plays for the first game based on the game asset applied to the set of plays for the first game. The steps also include returning, to the user interface, a payout for the adjusted set of plays for the first game.

In yet another aspect, the disclosure provides a game including a plurality of gaming elements, wherein each of the plurality of gaming elements includes a value and comprises a potential play in a wagering game. According to the game, a subset of the plurality of gaming elements further includes at least one game asset indicator which gives the player the ability to change an outcome of at least one of the plurality of gaming elements during play.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the present disclosure, and be protected by the following claims.

### BRIEF DESCRIPTION OF THE DRAWINGS

The present disclosure can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 depicts a gaming device according to an embodiment of the present disclosure;

FIG. 2 depicts a network environment in which aspects of the present disclosure may be implemented;

FIG. 3 depicts a flowchart of game play according to an embodiment of the present disclosure;

FIG. 4 depicts a data structure according to an embodiment of the present disclosure;

FIG. 5 depicts an electronic gaming screen according to an embodiment of the disclosure;

FIGS. 6A-6E depict example electronic gaming screens according to an embodiment of the disclosure;

FIGS. 7A-7E depict example electronic gaming screens according to another embodiment of the disclosure; and

FIG. 8 depicts a pay-out table according to an embodiment of the disclosure.

### DETAILED DESCRIPTION

The present disclosure is directed to methods and systems for implementing an enhanced wagering game. In particular, according to methods described herein, a player may earn at least one game asset to change one or more rules of a wagering game, or alter one or more gaming elements. “Game asset,” as used throughout the description, shall include any acquired ability to change the rules of a game and/or manipulate a gaming element, thereby positively affecting play for the player. For example, in some embodiments, a game asset may comprise a “superpower” that allows the player to change how points are accumulated, to replay portions of the game, to change point values within the game, and/or to customize rules of the game to enhance the player's experience. In other cases, instead of affecting the player's gaming element, a game asset could negatively affect the dealer or an opposing player, also ultimately enhancing the player's experience. In contrast, “game liability” may be used throughout the description to include any acquired change that either negatively affects play for the player or cancels or nullifies a pre-existing game asset. As discussed in more detail below, methods described herein may be implemented on a variety of gaming devices or systems. For example, electronic embodiments may be implemented on a casino-sized gaming machine, a kiosk, a hand-held game, a tablet, a casino table, or a personal computer. Methods may also be implemented in non-electronic formats, utilizing gaming elements configured for play according to principles described herein. Further, methods described herein may be applied to monetary wagering games as well as wagering games that accumulate points or some other non-monetary payback.

Utilizing electronic formats, the gaming methods described herein may be implemented on a variety of electronic gaming devices or systems, including but not limited to, a casino-sized gaming electronic machine, an electronic gaming kiosk, a hand-held gaming device, a tablet, a mobile phone or any other mobile device implementing methods described herein, or on a personal computer via an online-gaming system or other gaming application. Accordingly, in some embodiments, the methods may be implemented on a standalone gaming machine that may or may not be connected via a network connection to other computer resources, such as a network server or the Internet. However, in other embodiments, the methods may be implemented via a network server and accessed from a home computer or mobile device via a network, such as the Internet. Embodiments of the methods and system described herein may utilize various computer software and hardware components, including but not limited to, servers, mainframes, desktop computers, databases, computer-readable media, input/output devices, networking components and other components as would be known and understood by a person skilled in the art.

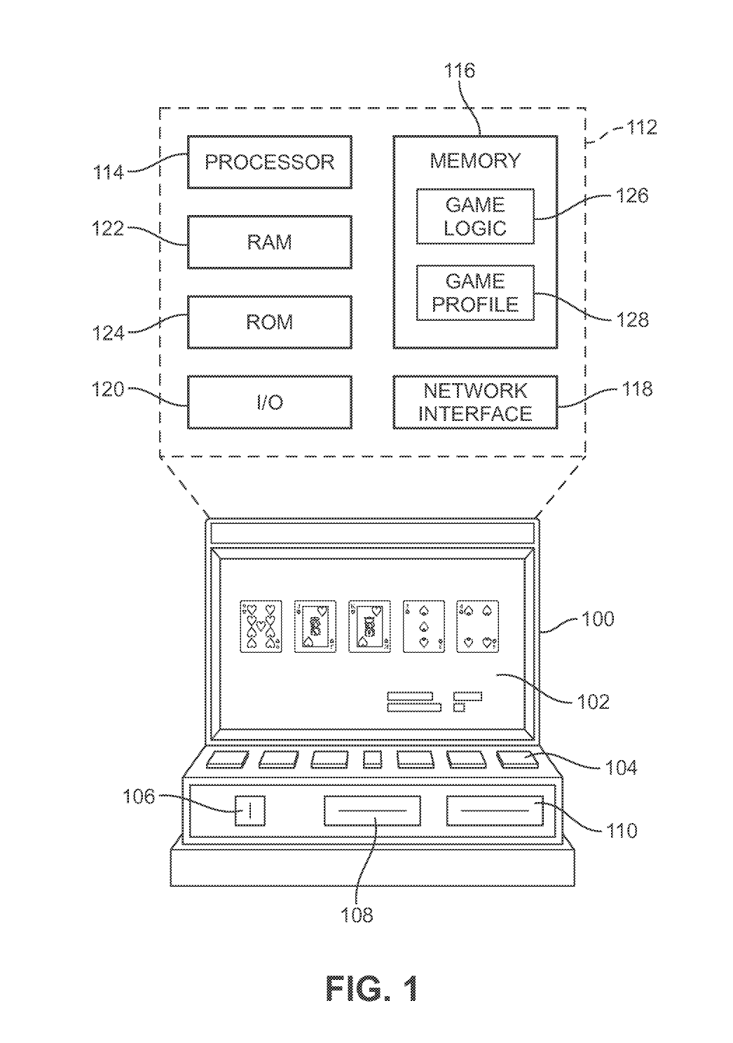

FIG. 1 depicts a stand-alone gaming device 100 in which methods described herein may be implemented according to at least one embodiment of the invention. As shown in FIG. 1, gaming device 100 may include a user interface 102 for displaying game details to a player, as well as various input/output devices. For example, gaming device 100 may incorporate input/output devices such as keyboard 104 for receiving player input; coin slot 106 for receiving player coins or tokens, card reader 108 for reading a credit card or other electronically readable card or voucher, such as a casino card or voucher; and output slot 110 for returning coins, receipts or other winnings to a player. In addition, in some embodiments, user interface 102 may also incorporate a touch screen for player input.

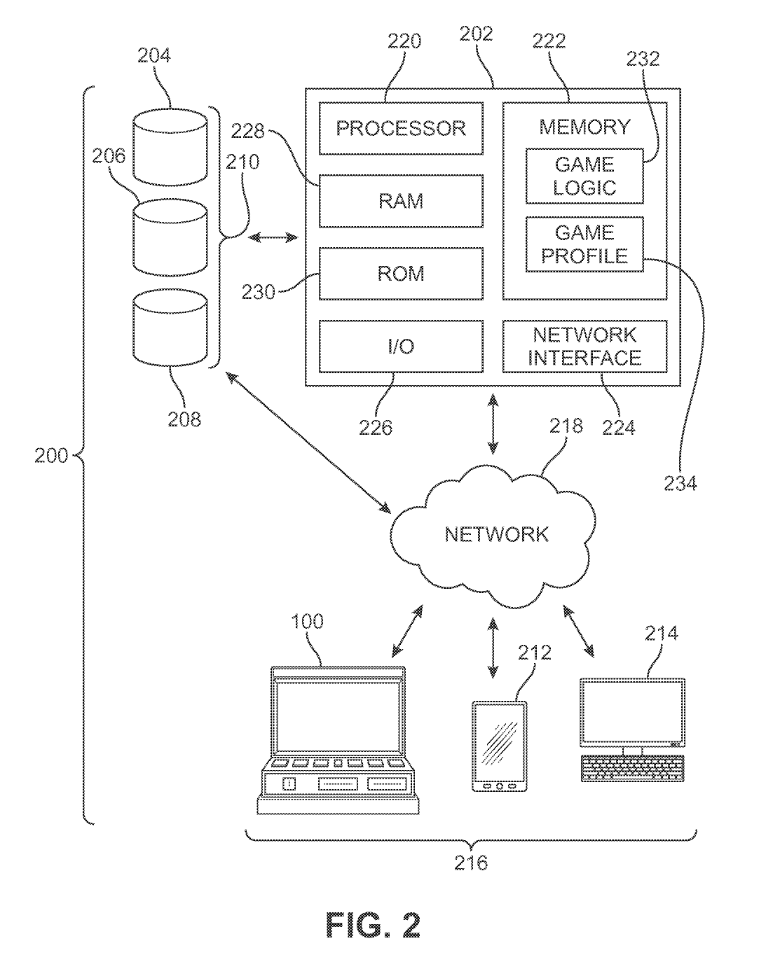

Gaming device 100 may further include a variety of internal mechanisms for driving one or more gaming systems and methods described herein, as generally represented in computer system 112, contained within gaming device 100. Computer system 112 may be configured as would be known by a skilled artisan and may include, but is not limited to, a microprocessor or processor 114, memory 116, one or more network interfaces 118, one or more input/output drivers 120 (such as drivers for video, voice, touch screen, keyboard, card reader, etc.), RAM 122, ROM 124, as well as other types of memory known in the art such as flash memory or EEPROM (not shown). Stored in memory 116 (or elsewhere), gaming device 100 may include a game logic module 126 for implementing gaming methods, and a game profile module 128 for storing player game profiles as described in more detail below. Processor 114 may include one or more local or distributed processors, controllers, or virtual machines. As would be understood in the art, processor module 114 may be configured in any convenient or desirable form as would be known by a skilled artisan. Memory 116 may comprise one or more electronic, magnetic, or optical data-storage devices, as well as game logic module 126 and game profile module 128. As would be known in the art, memory 116 may store instructions, such as game logic module 126, for processing by processor 112. Game logic module 124 may include machine readable and/or executable instructions sets for performing and/or facilitating performance of methods and rendering graphical user interfaces as further described herein, including sharing one or more portions of this functionality in a client-server architecture, over a wireless or wireline communications network, as discussed in more detail with respect to FIG. 2. The game logic may be embodied in a variety of known software systems, as would be known and implemented by a skilled artisan to effect the methods described herein.

FIG. 2 illustrates an example networked operating environment 200 in which aspects of the present disclosure may be further implemented. Environment 200 may include one or more servers 202, one or more databases 204, 206 and 208, collectively, databases 210, and one or more access devices, such as gaming device 100, handheld device 212 and computer 214, collectively access devices 216. Further, server 202, databases 210 and access devices 216 may include fewer or more than illustrated in FIG. 2, as would be understood and implemented by a skilled artisan.

Components of environment 200 may be connected to one or more networks, such as network 218, for communication between the components. Network 218 may be wired or wireless. In addition, in some embodiments, components depicted in FIG. 2 may be combined on one device. For example, server 202 and one or more of databases 210 may be physically located on the same device, and still function as described herein.

Server 202 is generally representative of one or more servers suitable for communicating with and providing game logic according to techniques described herein in the form of webpages or other markup language forms with associated applets, ActiveX controls, remote-invocation objects, or other related software and data structures, to service one or more access devices 216. Server 202 may be configured as would be known by a skilled artisan and may include a processor 220, memory 222, one or more network interfaces 224, one or more input/output devices 226, RAM 228, ROM 230, as well as other types of memory (not shown), a game logic module 232 for implementing gaming methods, and a game profile module 234 for storing player game profiles. In addition, access devices 216 and server 202 may communicate with databases 210 to access data stored in databases 210 such as game profiles or other game information.

Processor 220 may include one or more local or distributed processors, controllers, or virtual machines, or may be implemented in any convenient or desirable form as would be known by a skilled artisan. Memory 222 may comprise one or more electronic, magnetic, or optical data-storage devices, as well as store game logic module 232. As would be known in the art, memory 222 may store instructions, such as game logic module 232, for processing by processor 220. Game logic module 232 may include machine readable and/or executable instruction sets for performing and/or facilitating performance of methods and rendering graphical user interfaces as further described herein, including sharing one or more portions of this functionality in a client-server architecture, over a wireless or wireline communications network 218 with one or more access devices 216. The game logic may be embodied in a variety of known software systems.

Databases 210 may include one or more separate databases, such as database 204, database 206 and database 208. Further, as would be understood in the art, each of databases 210 may include one or more electronic, magnetic, optical data-storage devices, or other data-storage devices which can include or are otherwise associated with respective indices (not shown). In some embodiments, databases 210 include game profile or player profile data. In other embodiments, databases 210 include and/or extract game payment data. According to aspects described herein, databases 210 may be connected to server 202 directly or via a network 218.

As depicted, server 202 may include processor 220 which may further include one or more processors, processing circuits, or controllers. Processor 220 may be coupled to memory 222, which stores code (machine-readable or executable instructions) for server 202, as well as for processes performed by server 202. In at least one embodiment, memory 222 includes a game logic module 232 which may include computer-executable instructions for implementing gaming methods described herein. In addition, as would be understood by those skilled in the art, server 202 may include additional components for operation, such as RAM 228, ROM 230 and/or input/output mechanisms 226 (such as a keyboard, mouse, display, sound, etc.).

It should be understood that FIGS. 1 and 2 are merely examples of operating environments which would be suitable for implementing methods and systems described herein, and are not intended to suggest any limitation as to the scope or functionality of the present disclosure. Those skilled in the art will readily appreciate the variety of alternative operating environments in which aspects of the present disclosure could be implemented, as well as the variety and breadth of software and hardware that may be used interchangeably with the devices and systems depicted in FIGS. 1 and 2, and still fall within the spirit and scope of the present disclosure.

Game Asset Acquisition

According to aspects described herein, a player may acquire variants of one or more game assets before or during play that change the rules of the game during play. In some embodiments, a player may begin play with one or more game assets. For example, as described in more detail below, a player may acquire a game asset before play based on the player's ongoing game profile, based on an initial wager placed by the player, based on the results of a random variable which may be triggered by a player's initial wager, based on a player's game-playing history, or as a carryover game asset from a prior game. In other embodiments, a player may acquire a game asset during play, such as after a player makes a wager or after a first set of plays, such as a dealt hand of cards, a hand of cards obtained after a draw phase, or after a player rolls a set of dice. Further, it is possible that a player may acquire one or more game assets according to multiple methods.

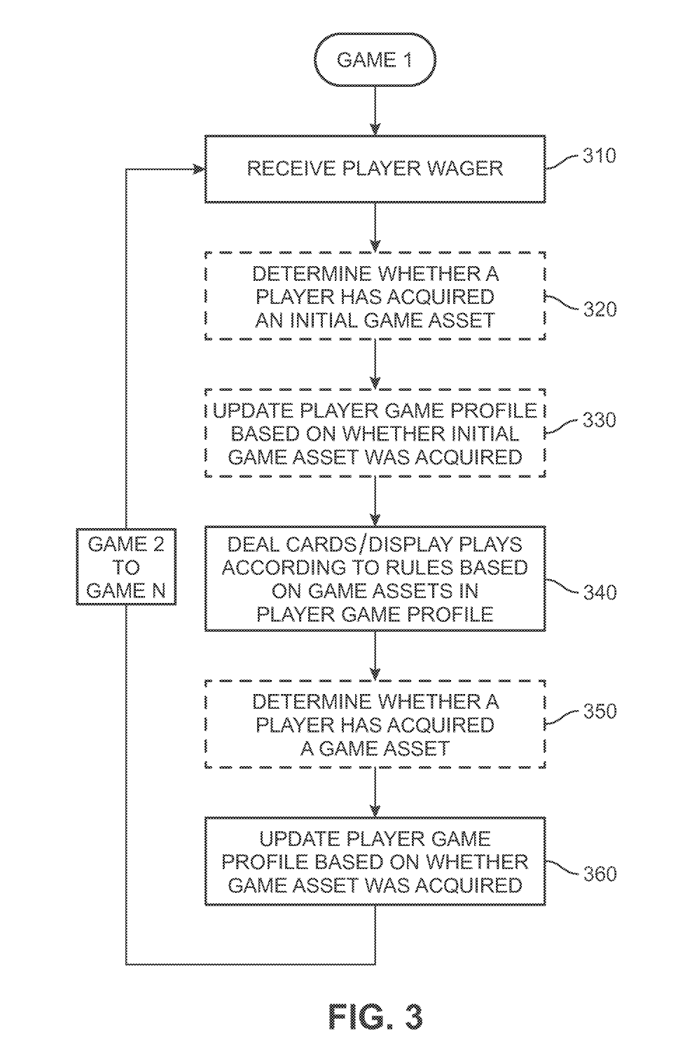

FIG. 3 depicts a flowchart of at least one embodiment of overall game play and acquisition of one or more game assets. At step 310, in an electronic embodiment, a server or other computer processor may first receive a player wager. Depending on the type of game being played, the wager may comprise an amount of money or number of coins, tokens, points, or any other type of wagering system used in game play. For example, in a standard video poker game in which “coins” (or a set amount of money representing a “coin”) are bet during play, the wager may equal a set number of coins, as discussed in more detail below. In some embodiments, at step 320 the processor may determine whether an initial game asset is acquired. The initial game asset may be based on a number of conditions set forth in more detail below, and may include whether the player made a wager over a pre-determined amount or if the player has played more than a pre-determined number of hands. At step 330, the processor may update a player game profile based on whether an initial game asset was acquired. As shown in FIG. 3, step 320 and step 330 are shown with dashed lines, indicating that some embodiments may not include acquiring an initial game asset, or may include this step earlier or later during play.

At step 340, the processor may generate plays and display the plays on a user interface, such as the screen of a gaming device 100 as shown in FIG. 1. The plays in step 340 may be based on a player's current game profile, including any game assets the player has acquired and holds. At step 350, the processor may determine whether the player has acquired a game asset, and at 360, the processor may update a player game profile based on whether a game asset was acquired. During steps 350 and 360, the processor may also adjust subsequent game play to reflect game rules consistent with the player's updated game profile. As discussed in more detail below, step 360 may include adjusting game rules to take advantage of one or more game assets that have been accrued. Again, step 350 is shown with dashed lines, indicating that some embodiments may not include acquiring a game asset after plays are displayed.

As introduced in step 360, a player game profile may be used to keep track of various statistics related to the player's current game and past games, as well as the player's gaming history. As discussed herein, the player's game profile may help determine whether the player acquires one or more game assets. A player game profile may be structured and implemented in a variety of different ways as would be readily contemplated by a person skilled in the art. For example, information related to a player's games and gaming history may be stored in memory in the form of a list or other data record. In other embodiments, the player information may be stored in a database, such as one or more databases 210 of FIG. 1. In still other embodiments, the player information may be stored in temporary memory, such as RAM, in the form of flags or in any other form as would be contemplated and implemented by a skilled artisan.

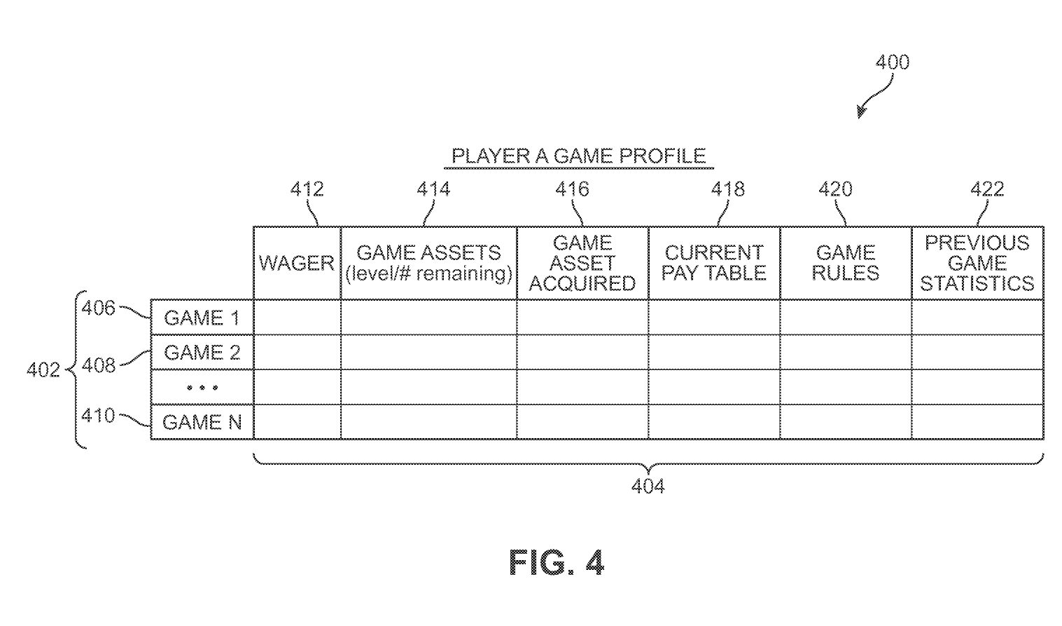

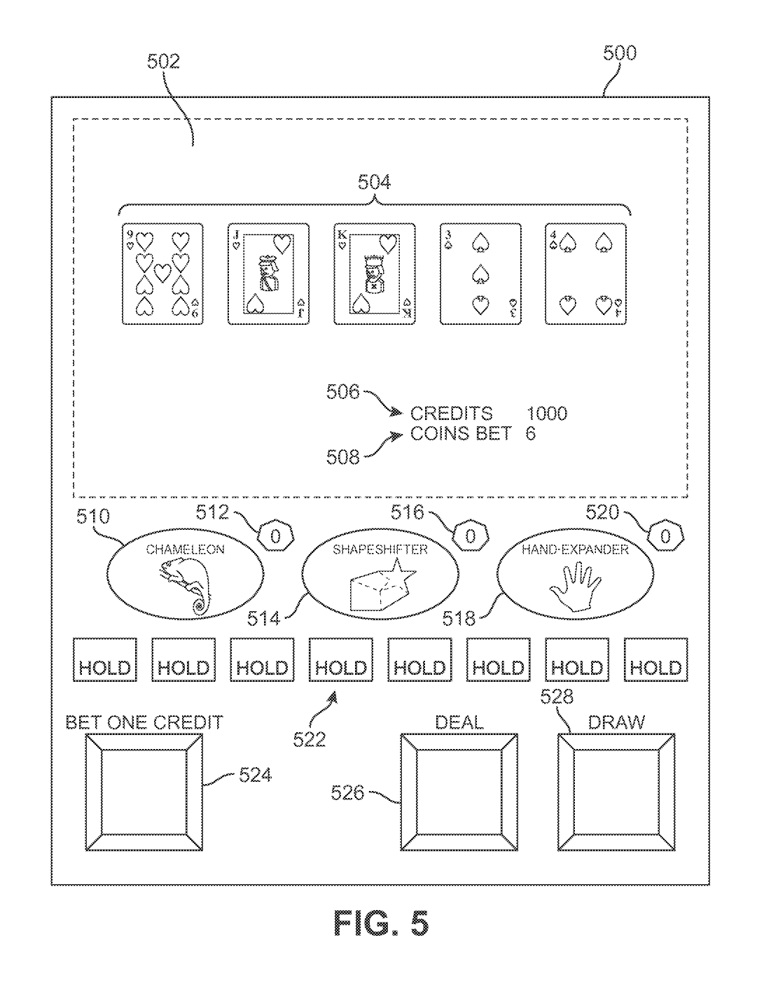

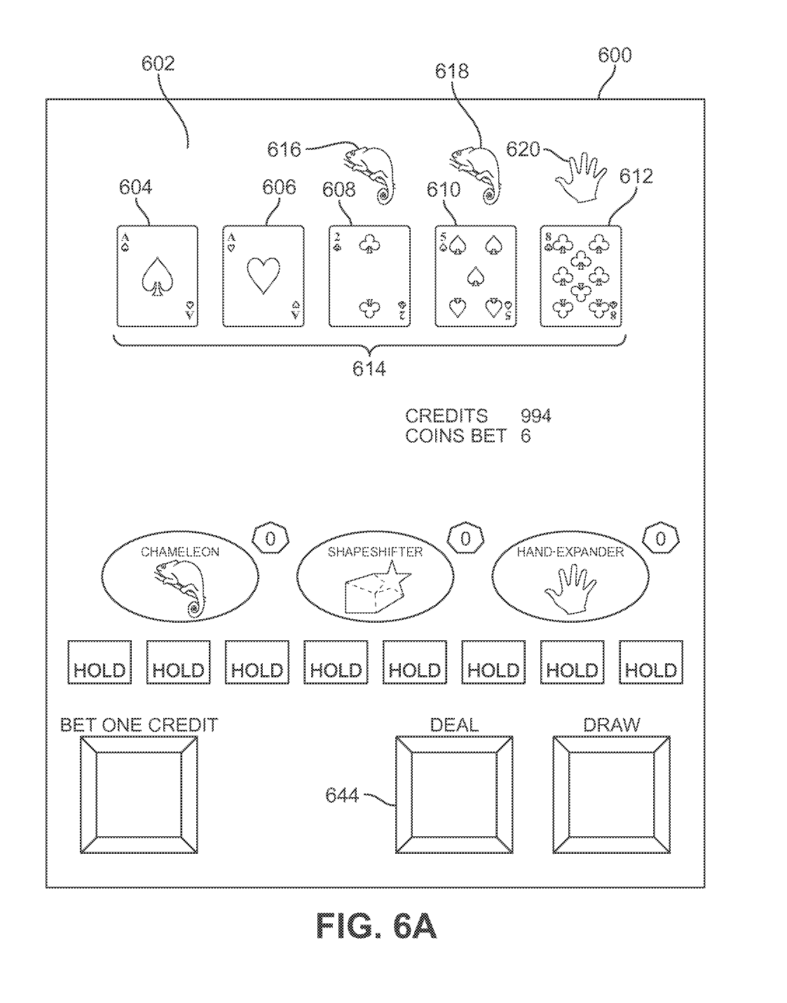

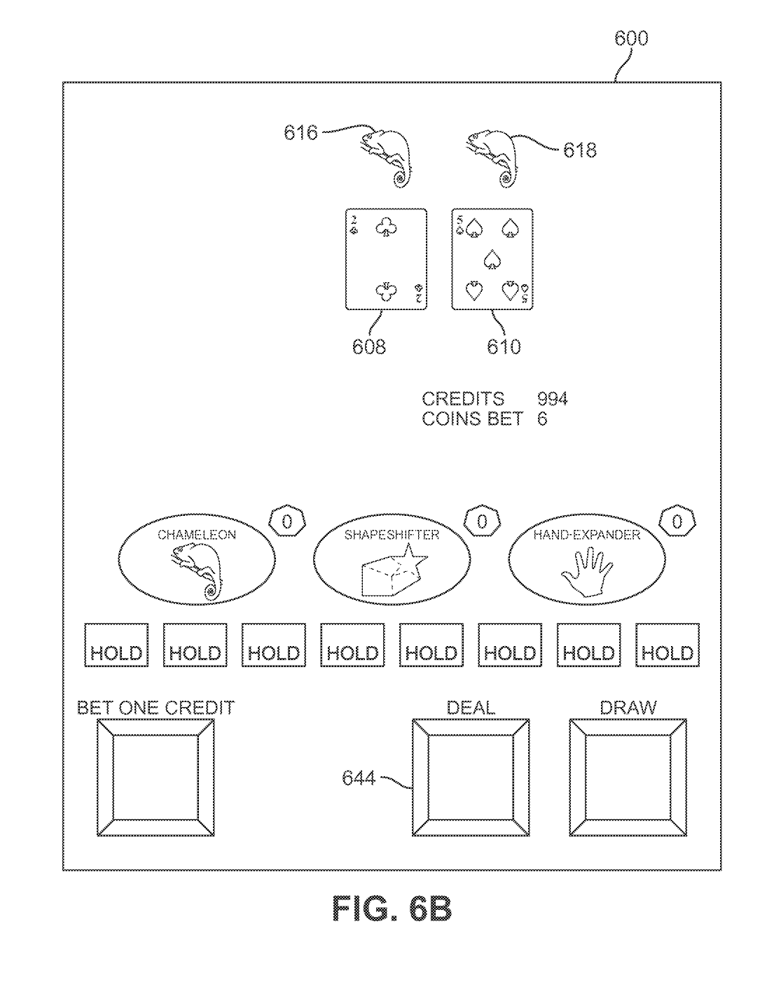

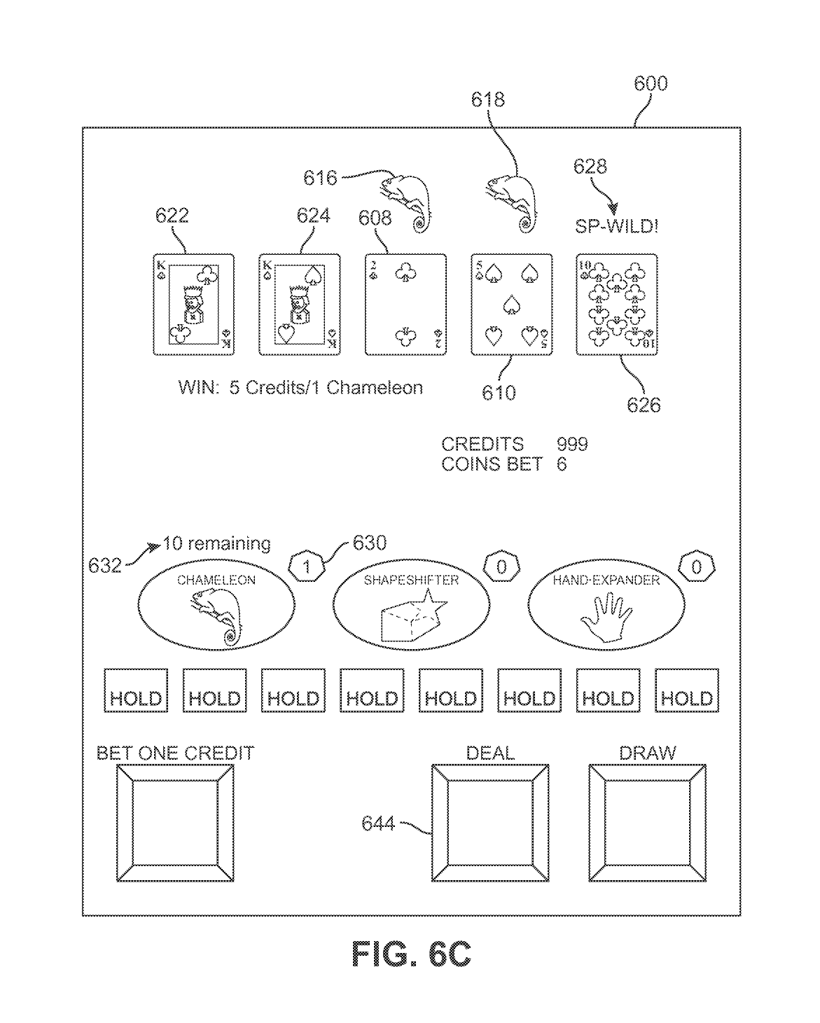

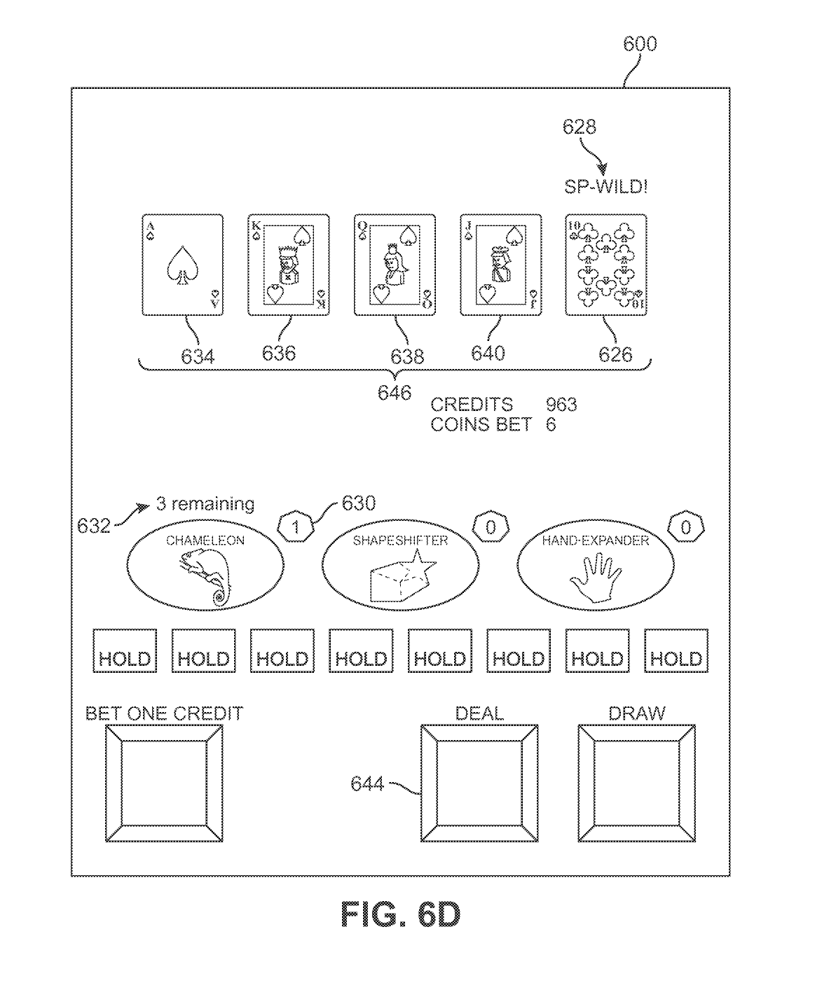

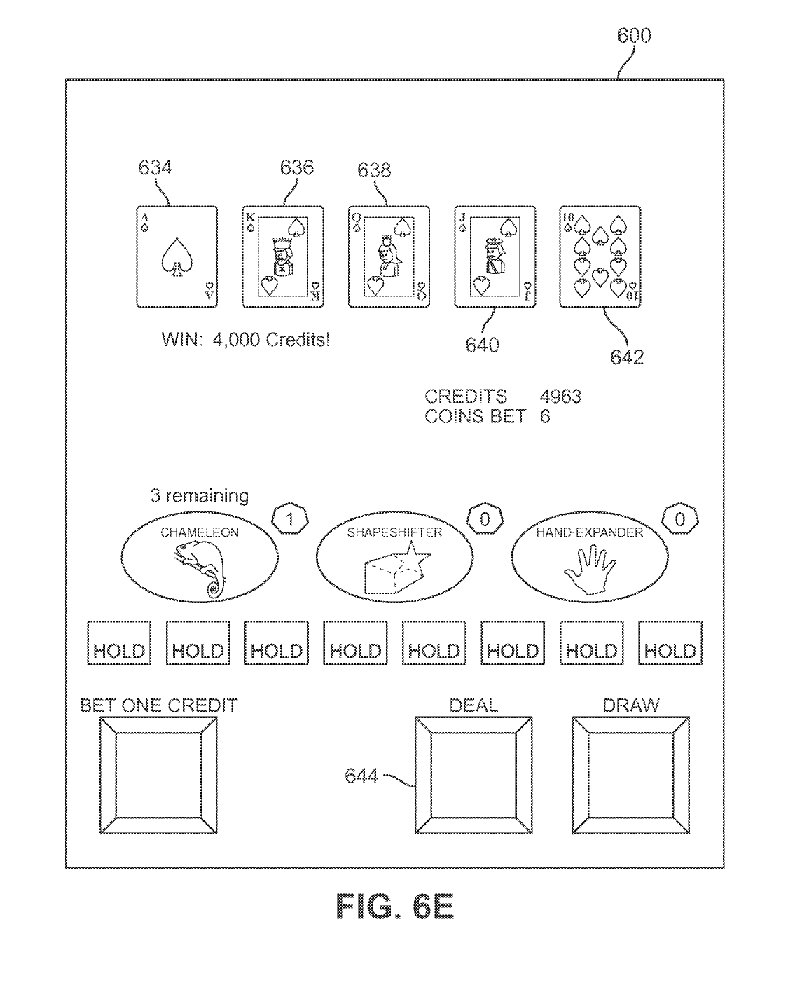

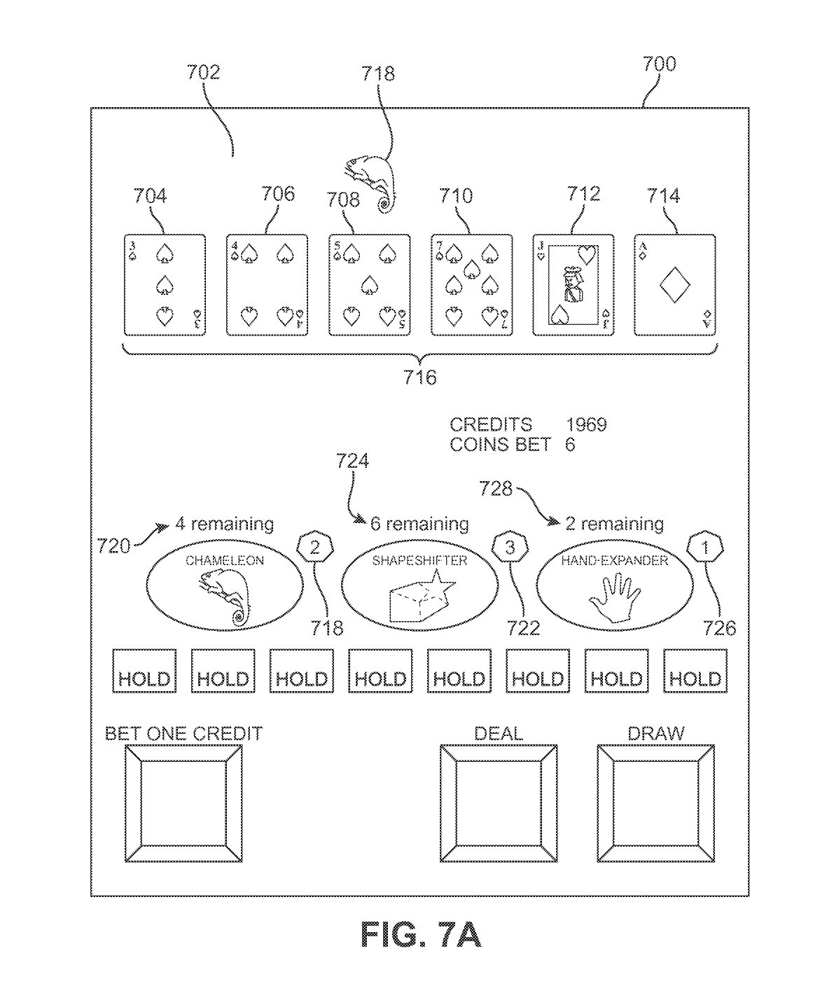

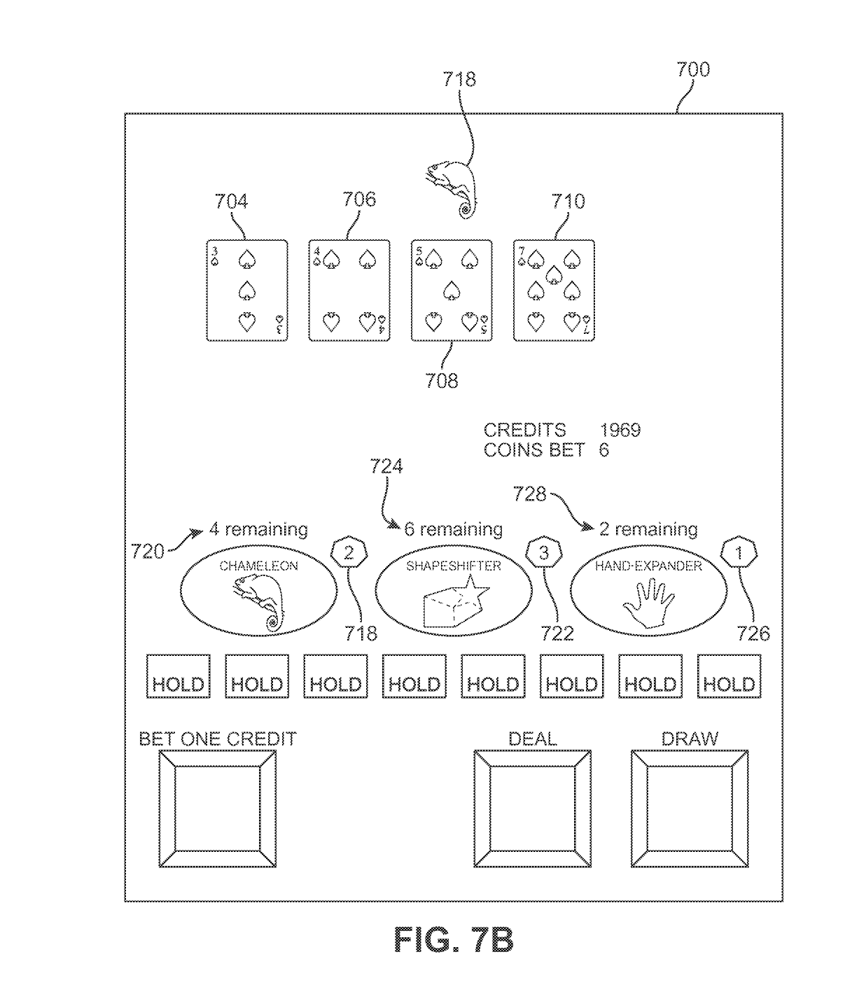

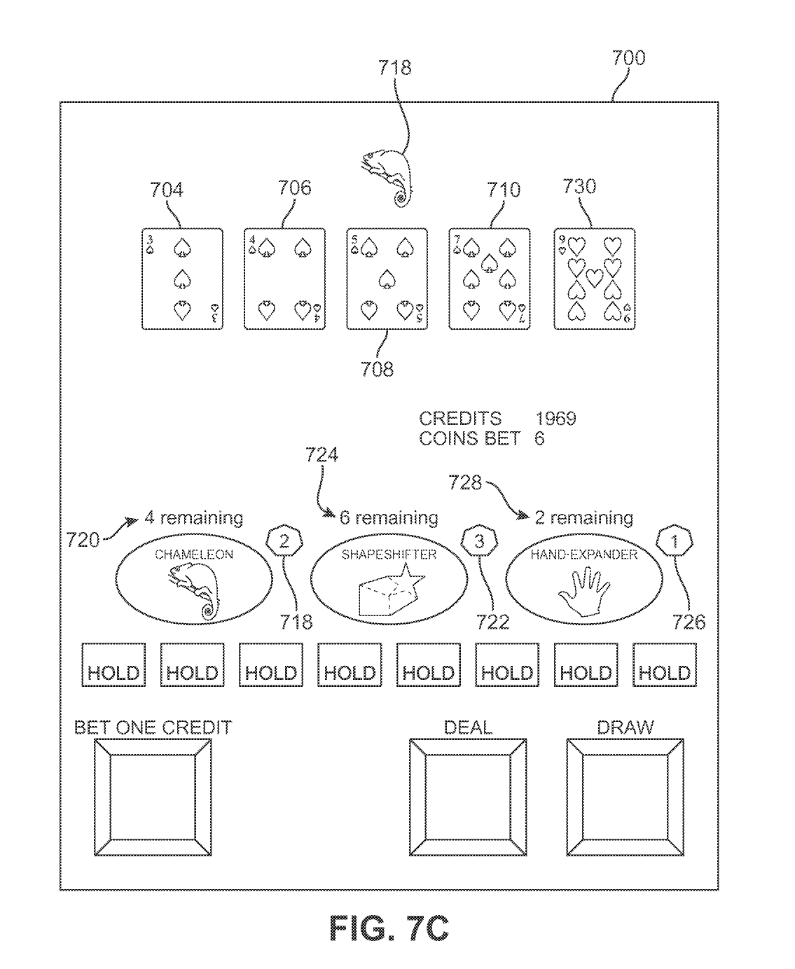

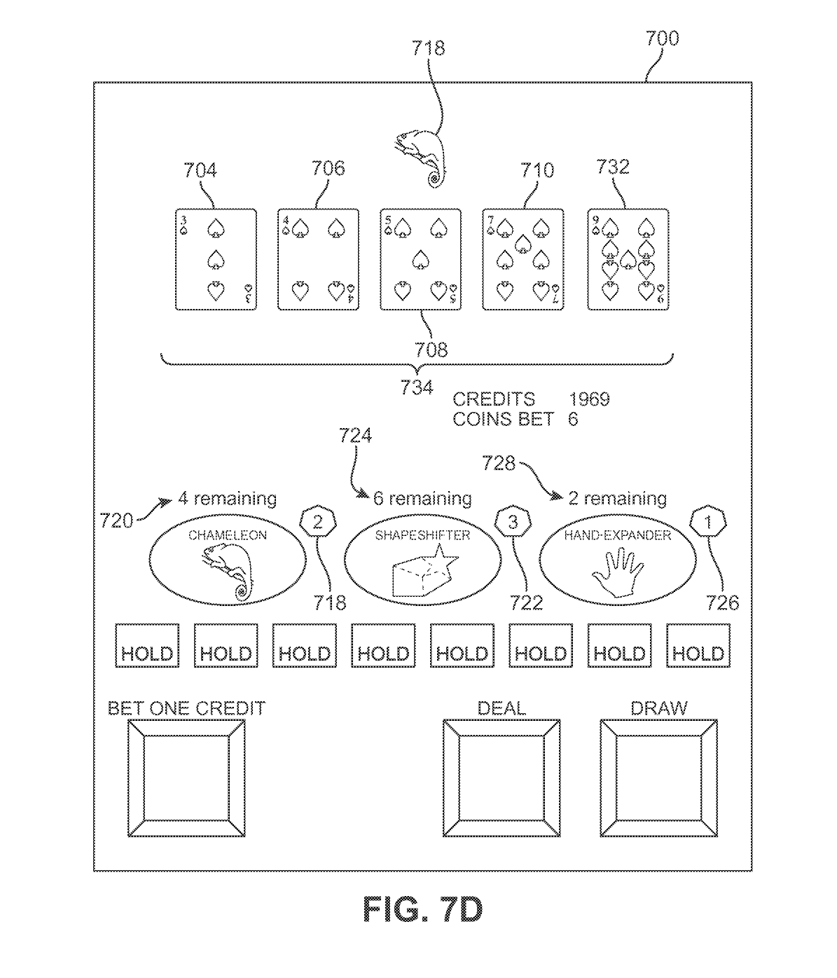

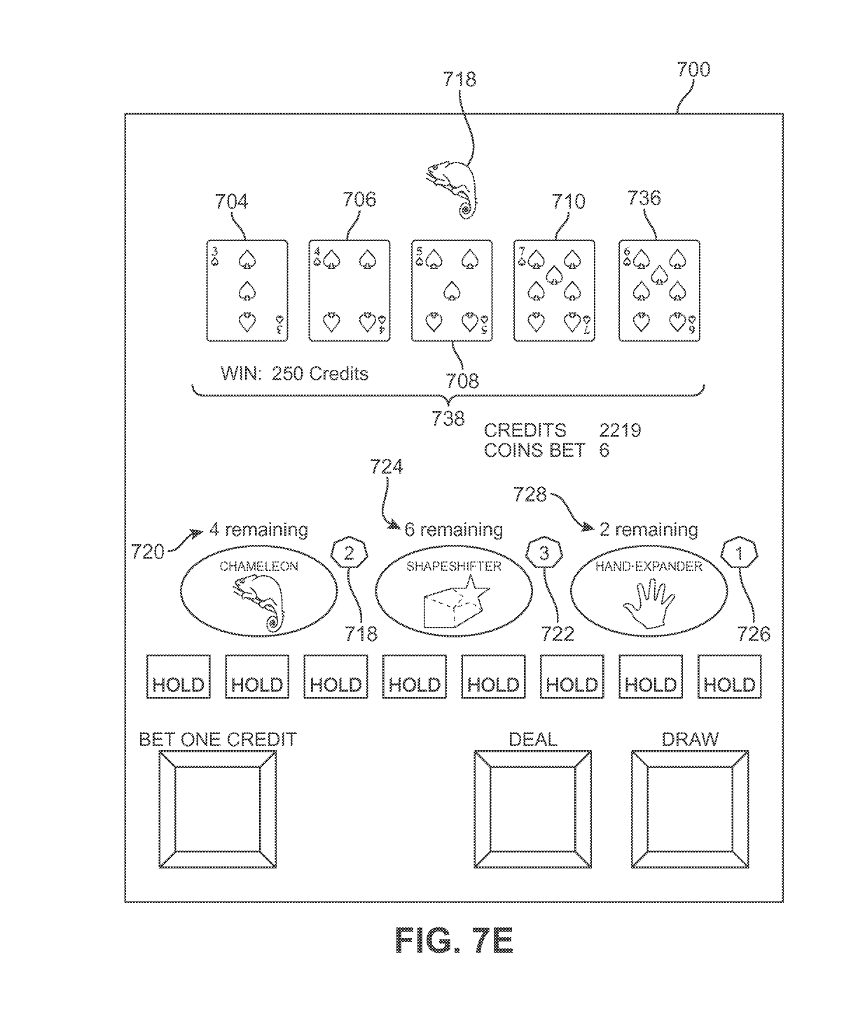

In at least one embodiment, a player game profile may be stored as a data record having a number of data entries. FIG. 4 depicts one embodiment of a player game profile data structure 400, related to a “Player A”. In player game profile data structure 400, rows 402 may each represent a game played by Player A. Specifically, GAME 1 row 406, GAME 2 row 408, and down to GAME N row 410, where “N” represents the total number of games played by Player A in a game session. Further, in player game profile data structure 400, columns 404 may each represent data items recorded and/or stored for a Player A as related to a particular game. In particular, column 412 may include a game wager; column 414 may include game assets to be applied in the particular game as well as the level of the game asset and the number of uses remaining; column 416 may include game assets that are acquired during a particular game; column 418 may include the pay-out table being applied in a particular game; column 420 may include the game rules being applied in a particular game; and column 422 may include prior statistics for Player A that may be relevant in a particular game. Player game profile data structure 400 may be stored in a memory of a stand-alone gaming device, a server, database, or other recordable memory location associated with one or more gaming devices. Again, player game profile data structure 400 is only exemplary and should not be interpreted as limiting as to the data structure itself or to the type of information included therein. For example, other types of information, such as a history of player wagering and a history of player pay-outs could be included. Furthermore, in non-electronic formats, player gaming information may be tracked by hand, by use of special gaming elements such as special playing cards, or by any other method contemplated by one of skill in the art. According to methods described herein, a player may acquire a game asset in a variety of ways. For purposes of explanation and example only, the discussion below will focus on various embodiments of game asset acquisition in an electronic format, and in particular, in the context of a video poker game, such as that depicted in FIG. 5. It should be readily understood, however, that the embodiments and the present disclosure are not limited to electronic gaming or to a video poker game, and could be implemented in a variety of different electronic and non-electronic gaming scenarios as would be contemplated by a person skilled in the art. Further, referring to FIG. 5 (as well as FIGS. 6A-6E and 7A-7E later in the description), the exemplary game of 5-card-draw video poker is depicted. While the present disclosure describes 5-card-draw video poker to facilitate explanation, it will be understood that other styles of poker (3-card or 7-card, other draw variants, stud variants, etc.), slot machines, other casino games including table games, non-casino games such as lotteries, and other non-card-based games are within the scope of the present teachings. Furthermore, it will be understood that aspects described herein may be carried out using a variety of gaming elements, including but not limited to, cards, dice, slot machines, roulette wheels, and lottery elements. Where the game is card-based, i.e., the gaming element comprises a card, in some embodiments a standard 52-card deck (possibly including one or more Jokers) and/or a set pay table may be used. However, in other embodiments, a modified card deck and/or a modified pay table may be used. Further, in some embodiments, the game may use standard variants of rules and pay-tables, including Jacks or Better, Deuces Wild, Double Double Bonus, and the like. In still other embodiments, custom variants may also be applied to the game.

Referring to FIG. 5, an example of a video poker game screen 500 is depicted. As described above, various embodiments will be explained in the context of video poker game screen 500, but video poker game screen 500 is only exemplary of how methods described herein may be implemented and should not be construed as limiting to the full breadth of the disclosure. Video poker game screen 500 may be implemented in a variety of electronic gaming scenarios such as that of electronic gaming device 100 shown in FIG. 1, or any other electronic gaming scenario, including but not limited to electronic gaming devices 216 shown in FIG. 2 and described above. In at least one embodiment, video poker game screen 500 may comprise a touchscreen, in that it serves as both a graphical user interface displaying portions of an electronic game, and an input device via touch-activated buttons, e.g. hold buttons 522; bet button 524, deal button 526 and draw button 528. In other embodiments, however, input buttons may be embodied in a keyboard or other input device known in the art. As shown in FIG. 5, video poker game screen 500 may include a game area 502, where various game plays are displayed. In FIG. 5, game area 502 depicts a five-card draw video poker hand 504. Game area 502 also may include a credit indication 506, indicating how many game, monetary or other credits a player has accrued, as well as a wager indication 508.

In some embodiments, an electronic game screen may also include an indication of any game assets that have been acquired. According to at least one embodiment, video poker game screen 500 may include game asset indicator 510 and associated level indicator 512, game asset indicator 514 and associated level indicator 516, and game asset indicator 518 and associated level indicator 520. In video poker game screen 500, game asset indicator 510, game asset indicator 516 and game asset indicator 520 each reflect various “superpowers” that may be acquired according to the example described herein. Specifically, game asset indicator 510 indicates whether a “Chameleon” superpower has been acquired; game asset indicator 514 indicates whether a “Shapeshifter” superpower has been acquired; and game asset indicator 518 indicates whether a “Hand-expander” superpower has been acquired. Associated level indicator 512, level indicator 516, and level indicator 520 indicate how many iterations or levels of the respective superpower have been acquired and/or how many of the respective superpower remain to be used by the player. Video poker game screen 500 may also include an indicator for each superpower identifying how many uses are remaining (not shown in FIG. 5). Superpowers “Chameleon,” “Shapeshifter” and “Hand-expander” will be discussed in more detail below; however, it will be understood that these are only exemplary, and any other game asset or superpower could be included in video poker game screen 500.

According to methods described herein, a player may acquire a game asset by accruing game asset points within the game being played. For example, using video poker as an example wherein the game asset is a superpower that may be acquired by the player to change rules of the poker game, the player may be dealt cards wherein one or more “superpower icons” representing various superpowers are placed on individual cards within the 52-card deck. For example, within a 52-card deck, there may be four “Chameleon” icons placed on either a random or predetermined set of cards, such as the Two of Clubs, the Five of Spades, the Eight of Hearts, and the Ten of Diamonds. When the player achieves, post-draw, a hand containing a pre-determined number of cards having a “Chameleon” icon, such as three of the cards—the Two of Clubs, the Five of Spades and the Eight of Hearts—that hand may provide a level of the “Chameleon” superpower. Similarly, a hand containing a greater number of the same superpower icon could provide higher levels of the superpower in question. As an additional alternative, superpower icons could be generic and applicable to any superpower. In this embodiment, matching superpower icons may enable the player to progress towards obtaining a superpower of his or her choice, to be awarded after the player acquires a pre-determined number of matches. In at least one embodiment, any given hand may qualify for acquiring a superpower, a payout under the governing poker-hand pay-table, or both.

Other embodiments may feature alternative methods of game asset acquisition. Using the same video poker example as a context, one such alternative embodiment of acquiring a game asset, or “superpower,” may include acquiring a superpower that is randomly generated by the game logic processor of an electronic gaming device. In some cases, this embodiment could include generating the superpower more frequently (or exclusively) when a player makes a maximum wager. Other alternative embodiments of superpower acquisition could include, but are not limited to: a player being dealt a hand of a certain rank or higher (i.e., Three-of-a-Kind or better); a player achieving a hand of a certain rank or higher after a draw (i.e., Four-of-a-Kind or better); based on the player having played more than a pre-determined number of hands; based on the player having played more than a pre-determined length of time; based on the rate of the player's play (i.e., number of hands initiated or wagers made per unit of time); based on the player having accumulated more than a pre-determined number of losses; based on the player having fewer than a pre-determined number of good hands over a particular period of play (e.g., at least 250 hands since the player hit a hand of Four-of-a-Kind or better after the draw); and, other unique cards added to the 52-card deck that, singly or in combination, provide a superpower. In some embodiments, the game asset obtained may be randomly determined by the game logic for the electronic gaming device. In other cases, the game asset that is acquired may be chosen by the player. In still other cases, the game asset may be based on the underlying method of acquisition, for example, if a superpower in a video poker game is acquired by being dealt a Three-of-a-Kind, being dealt three Eights may provide one superpower, whereas being dealt three Queens could provide a different superpower. Alternatively, acquisition could be provided automatically, for example, by the casino to certain players as a promotion or by having a special players card.

Game Asset Duration and “Levelling Up”

Just as there are a variety of ways in which a game asset (in the present example, a “superpower”) may be acquired, there are also many possible variants for how long a superpower may last. For example, in some cases, the superpower may last a pre-determined number of dealt hands. The pre-determined number may be either randomly determined by the game logic or it may be a constant. In other cases, the superpower may last a set length of time. In such a case, the player may be encouraged to play faster. In another case, the duration of the superpower may be based on changes to the player's bankroll, i.e., the superpower may end after a set amount of money, points or tokens, for example, have been won or lost. In another embodiment, the duration of the superpower may be based on whether the player has achieved a hand above a pre-determined rank. For example, the superpower might end when the player hits a Four-of-a-Kind, or higher, post-draw. In yet another embodiment, where only one active superpower is allowed at a time, the superpower may last until a next superpower is acquired. In still other cases, once achieved, the superpower could be continuously available to the player, could be available for a limited number of times, or could be available to the player only once. Accordingly, it should be understood that there are a variety of ways for implementing a duration for a game asset, and the breadth herein should not be considered limited by the specific examples that are given.

In one embodiment, the player may retain the game asset indefinitely until it is used or until a pre-determined jackpot or payout is obtained. Additionally, in some embodiments, players may have the option of acquiring more than one game asset at the same time. In these or alternative variants, acquiring the same game asset more than once may cause the player to “level up” and to obtain a more advantageous higher level of the game asset or superpower. Under “level up” circumstances, it is contemplated that players could continue to retain their game assets until an ending event takes place. Examples of ending events may include: if a player dissipates all game assets in the course of obtaining one or more non-jackpot payouts; if the player obtains a specified jackpot payout (e.g., a Royal Flush payout), causing the game assets to reset to zero; or if the player obtains the maximum level of all game assets, potentially causing a “cashout bonus” of a lesser jackpot, following which the game assets reset to zero.

It is further contemplated that a player may retain various levels of one or more game assets indefinitely over time, with the ability to use the one or more game assets in subsequent game sessions as a carry-over game asset. For example, a player may retain a game asset for multiple sessions of play, broken up by periods of non-play. According to aspects disclosed herein, information, such as a player's carry-over game asset may be stored in a player game profile data structure 400, such as discussed in relation to FIG. 400, and saved in the memory of a standalone gaming device or on a networked server or database. In other cases, a player's status may be saved by the player on one or more mobile storage devices. For example, a player could use a PIN-protected casino player's card, enabling the player to resume game status after a break by having an electronic gaming device read the current status and level of active game assets from the card.

In some variants, as discussed above, a player may obtain a game asset that the player can use repeatedly and without limitation over many hands. In this embodiment, leveling up becomes even more advantageous, enabling the player to retain the higher levels of the power until some terminating event occurs. Such terminating events can include the factors described above. As an additional terminating or limiting event in this or other embodiments, a game liability (e.g., a “super-villain”) symbol may be placed on certain cards, with the power to dispel or reduce superpowers. Alternatively, any of the embodiments described above in relation to game asset acquisition could instead be used to dispel or reduce superpowers.

Game Assets

Game assets may be acquired by a player in a number of different ways as described above. In addition, game assets may be implemented to positively affect a player's game in variety of ways. In some cases, the game assets may be specific to the type of game being played. For example, a game asset specific to a slot machine game might be the ability to move a slot reel up or down by one notch. In other cases, a game asset may be applicable to any type of game or gaming element, such as the ability to change plays, re-draw cards, or to change the value of a die, a card or a spin, all inuring to the player's benefit during game play. In addition, game assets may exist at multiple levels or intensities. For example, a lower level of a game asset may allow a player to make a change to one card in a card game, whereas a higher level of the same game asset may allow a player to make a change to more than one card in a card game. Further, some game assets may have limits on when they may be used, such as before or after the draw phase of a video draw poker game.

A number of example game assets are set forth below in accordance with various embodiments of the disclosure. The examples set forth below are described in the context of an electronic video poker game and may be considered alternately referred to as a “superpower,” as previously described. Those skilled in the art will recognize that the game assets may be applied in a variety of contexts, including a variety of electronic wagering games.

X-ray Vision: An “x-ray vision” game asset or superpower may enable the player to see the next card or cards to be dealt in the draw phase of the game. Different levels of this superpower may enable the player to see one, two or three or more cards into the replacement draw. Alternative implementations of this power may enable the player to shuffle a deck of replacement cards after seeing the top replacement cards. In other embodiments or in a different game context, an “x-ray vision” game asset may allow a player to see subsequent plays before they are played. For example, a player may be able to see the result of a roll of a die before it is rolled.

Chameleon: A “chameleon” game asset or superpower may enable the player to change the suit of one or more cards, for example from a King of Clubs to a King of Diamonds. Different levels of this superpower may enable the player to change the suit of multiple cards; alternatively, a lower level may only allow changing suits to one of the same color (i.e., Hearts could be changed only to Diamonds), and higher levels may allow changing to any suit. This superpower may include an option of whether to allow multiple versions of the same card in the game. For example, if the player is dealt both a Ten of Hearts and a Ten of Diamonds, the question arises whether the player would be allowed to convert the Ten of Hearts into a second, duplicate Ten of Diamonds to complete a Flush. In other embodiments or in a different game context, a “chameleon” game asset may allow a player to change a play in a wagering game. For example, the “chameleon” game asset could be applied in non-card games, such as changing the color of a number on a roulette wheel or a slot reel.

Shape Shifter: A “shape shifter” game asset or superpower may enable the player to change the rank of one of his cards to an adjacent rank within the same suit, for example from a Jack of Hearts to either a Ten of Hearts or a Queen of Hearts. Different levels of this superpower may enable the player to change the rank by two or three increments or may enable the player to affect the rank of multiple cards. In other embodiments or in a different game context, a “shape shifter” game asset could be applied to change a play to an adjacent play in a wagering game. For example, the player may be able to change a number on a roulette wheel to an adjacent number, move a slot machine up or down by one notch, change a number on a die/dice, change the number of pips on a domino, or otherwise change the value of a gaming element.

Time Travel: A “time travel” game asset or superpower may enable the player to re-execute a draw on which a positive outcome was not achieved (that is, to return to the pre-draw phase of the game and to re-execute the draw using a new random pool of the 47 remaining cards). This corresponds to an “undo” and “re-do” function. Different levels of this superpower could enable the redraw to be executed multiple times. In other embodiments or in a different game context, a “time travel” game asset could be utilized to re-execute any type of wagering play. It is contemplated that a “time travel” game asset may be utilized to re-execute the immediately preceding draw or to re-execute any preceding draw in the game.

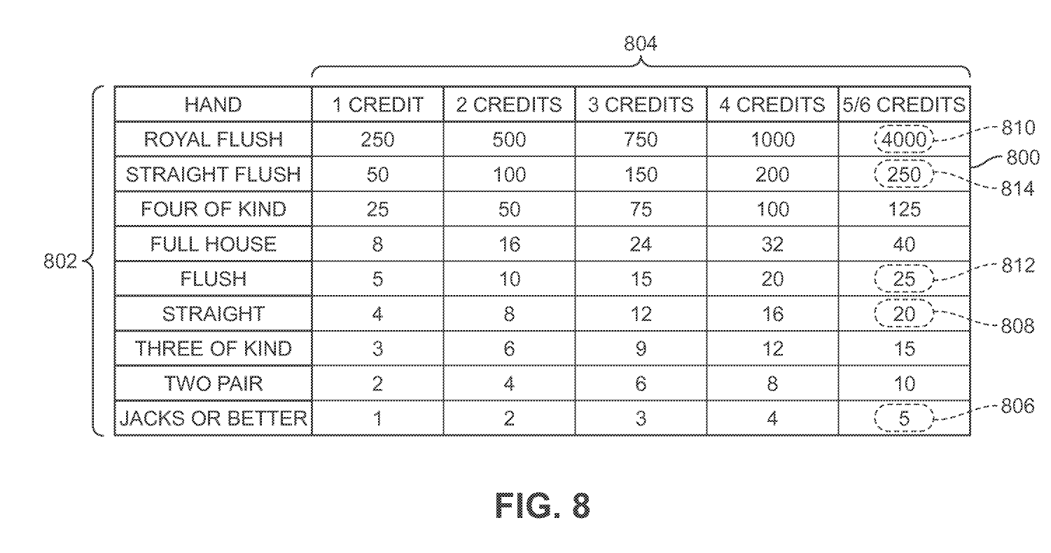

Game Changer: A “game changer” game asset or superpower may enable the player to change an underlying pay-table and/or rule structure of the game being played. For example, changing from a Jacks or Better pay-table (e.g, as depicted in FIG. 8) to a Double Double Bonus pay-table (not shown) may pay more than 6 times the payout to an identical hand, as would be understood in the art. As a further example, changing to a Deuces Wild pay-table (not shown) would allow Deuces to be considered wild. In one embodiment, the base level of this power could enable the player to add the pay-table/rules of one additional game, effectively enabling the player to take the higher payout of the two pay-tables during the exercise of the superpower. Higher levels might allow the choice of three or more pay-tables/rule structures, or to exercise the power pre-draw as opposed to post-draw.

Transmogrify: A “transmogrify” game asset or superpower may enable the player to change one card into any other card not already in the player's hand. For example, a player could change the Jack of Spades into the Three of Diamonds. In other embodiments or in a different game context, a “transmogrify” game asset could be utilized, for example, to change a play into another play not already showing on the screen or in a player's hand. In non-card game contexts, a “transmogrify” game asset could be used to change an icon on a slot machine or to change a number on a wheel.

Replicator: A “replicator” game asset or superpower may enable the player to take multiple draws at the same hand. For example, a player drawing to four cards to a Royal Flush might use the superpower to change a single-line game (in which the player has a 1 in 47 chance of hitting the Royal Flush) into a multi-play game (in which the player would have 2, 3, 5 or more chances in 47 of hitting the Royal Flush and might hit it multiple times). In other embodiments or in a different game context, the “replicator” game asset could be used to execute more plays, improving odds of a winning outcome.

In yet another embodiment, a player could duplicate a rank of one of the dealt cards in subsequent cards to his benefit. For example, in a four card game, a player may duplicate a rank of one of the first three cards to be dealt. In other words, if the player is dealt Ace of Hearts, Five of Diamonds and Eight of Clubs, the player could replicate the Ace, and the fourth card would come out as the Ace of Spades, generating a winning hand with one more card to come.

In still another embodiment, a player may affect the pool of cards from which replacement cards will be dealt by replicating desired cards. For example, a player drawing to three Aces may replicate the final Ace such that identical versions of that card would represent two, three, or more cards in the replacement pool.

Hand Expander: According to one embodiment, a “hand expander” game asset or superpower may enable an extra initial dealt card for each level of the power. For example, in one case, the player could initially be dealt seven cards. After the player discards at least two cards, the player may be re-dealt cards to generate a final, post-draw hand of no more than five cards. In another case, the player's hand could be expanded post-draw, with extra cards being dealt as part of the draw phase, then narrowed to the best five-card hand.

Flash: A “flash” game asset or superpower may enable the player to have access to a higher pay table for a limited period of time. For example, using a “flash” game asset, a player might access a double-payout pay table for two minutes of play. Accordingly, embodiments of the “flash” game asset reward the player for having the skill of playing relatively accurately while playing quickly. In other embodiments, higher levels of this power could be implemented by increasing either the enhancement of the pay-table or the length of time the power is available. In still other embodiments or in a different game context, the “flash” game asset could be used on another wagering game to increase the payout on any play for a pre-determined (or randomly determined) period of time.

Twister: A “twister” game asset or superpower may enable the player to implement a second draw phase after the first draw has been completed. According to one embodiment, a lowest level of the superpower may allow the player to conduct a second draw phase of no more than one card (a “twist”). In other embodiments, higher levels of the superpower may enable the player to exchange two or more cards in the second draw phase or to twist one card multiple times. In still other embodiments or in a different game context, the “twister” game asset could be used on any type of wagering game to implement additional plays or partial plays.

Bet Spreader: A “bet spreader” game asset or superpower may allow the player to select a hand which increases the size of the wager after seeing either the initial set of cards or the final, post-draw hand. In some embodiments, the player may select a plurality of hands. Further, the player may choose to decrease the size of the wager. In other embodiments or in a different game context, the “bet spreader” game asset could be used on any type of wagering game to alter the wager at an advantageous point in the game based on seeing plays or other increased information.

Surrender: A “surrender” game asset or superpower may allow the player to “surrender” (i.e., make no wager on) an initial set of five cards. In some cases, under this game asset the player may surrender multiple times. In some cases, there may be a limit to the number of hands in which this game asset could be evoked, and in other cases, no limit. In other embodiments or in a different game context, the “surrender” game asset could be used on any type of wagering game to allow the player to make no wager at an advantageous point in the game after seeing a play or other increased information.

Banisher: A “banisher” game asset or superpower may allow the player to affect the pool of cards from which replacement cards are dealt. In some cases, this may include eliminating undesired cards from the pool of cards. For example, a player drawing to four-cards-to-a-Royal-Flush may eliminate all Threes from the replacement cards, thereby making it more likely that the Royal Flush will be hit. In other cases, however, the game asset may include decreasing the number of cards in the pool of cards. At a higher level, the player may be able to banish an entire suit of disfavored replacement cards. In other embodiments or in a different game context, the “banisher” game asset could be used on any type of wagering game to allow the player to eliminate unfavorable plays from possible plays or outcomes. In a non-card context, this could include constraining a roulette wheel such that it only landed on a black number.

Gambler's fallacy: A “gambler's fallacy” game asset or superpower may allow the player, after a number of consecutive losing hands, to become “due,” and thereby guarantee a winning hand, such as by being dealt a “made hand” consisting of a configuration that, even before the draw phase, would be entitled to payment. In other embodiments or in a different game context, the “gambler's fallacy” game asset could be used on any type of wagering game to allow the player to receive a winning play.

Omniscience: An “omniscience” game asset or superpower may allow the player to receive information on the mathematically correct way to play each hand for as long as the power lasts. In other embodiments or in a different game context, the “omniscience” game asset could be used on any type of wagering game to allow the player to improve his chances with mathematical information on how to play or wager.

The Joker: “The joker” game asset or superpower may add a Joker (which may operate as a wild card) to a playing deck. In some embodiments, the number of jokers added to the deck could be increased for higher levels of the game asset. In some cases, it may be necessary to modify the pay-table when “the joker” game asset is in play. In other embodiments or in a different game context, “the joker” game asset could be used on any type of wagering game, adding some sort of “wild” play to the universe of plays, wherein the wild play would inure to the player's benefit.

Wild Man of Borneo: A “wild man of Borneo” game asset or superpower may allow the player to identify one or more cards that could count as a unique wild card for the player. According to one embodiment, a player may identify the wild card pre-deal. However, in other cases, the player might identify the wild card after cards have been dealt. In some cases, additional wild cards could be added for each level of the game asset. In some cases, it may be necessary to modify the pay-table when the “wild man of Borneo” game asset is in play. In still other embodiments or in a different game context, the “wild man of Borneo” game asset could be used on any type of wagering game, adding a user-selected “wild” play to the universe of plays, wherein the wild play would inure to the player's benefit.

Banker: A “banker” superpower may allow the player, after the initial set of cards has been dealt, to receive an offer to buy out the draw phase (e.g., to provide the player a payment in exchange for terminating the hand at that point). In some embodiments, the offer could be a pre-determined amount. In other embodiments, the offer may be randomly determined. In at least one case, the offer may be set at a range of 90-120% of the mathematical expectation for the hand, either pre-set or randomly determined.

Mathemagician: A “mathemagician” game asset or superpower may allow the player to combine cards using mathematical functions. In one embodiment, for example, the player may be able to combine a card of rank Three and a card of rank Six to create a card of rank Nine. In some cases, the player may be able to determine the suit of the new card, however, in other cases the card could be randomly determined. In some cases, a new replacement card may be dealt to replace the missing card.

It should be understood that the game assets identified above are only exemplary and should not be construed as limiting to the present disclosure. Those skilled in the art will recognize that there are many further embodiments and variants of the superpowers described above that may be incorporated into methods and systems described herein.

### EXAMPLES

FIGS. 6A-6E and FIGS. 7A-7E, described in more detail below, depict two examples of a video poker game being played according to embodiments described herein. The following examples are provided to illustrate how various game assets may be executed during play, and should not be viewed as limiting to the entirety of the disclosure. For example, as detailed above, the specifics of any particular game could be customized by the player depending on the options presented to the player. As such, the play in the examples is merely illustrative and could have various outcomes.

### Example 1

FIGS. 6A-6E depict an example of play in a video poker game wherein three game assets are offered, each with three different levels or intensities. The first game asset is Chameleon. At its lowest level, the example implementation of Chameleon allows the player to change one card, either pre- or post-draw, to a card of the same rank, but having a different suit of the same color. As implemented in the example, the Chameleon superpower may not be used to duplicate a card already in the player's hand. The second level allows the player to change any one card to any different suit of the same rank, although again no duplication of cards is allowed. The third level allows the player to change any two cards to any different suits of the same rank, again with no duplication.

The second superpower in Example 1 is Shape Shifter. At its lowest level, the example implementation of Shape Shifter allows the player to change one card to a card of an adjacent rank of the same suit (i.e., a Four of Diamonds to a Five of Diamonds). As with all levels of Chameleon, no duplication of cards is permitted in the example. At the second level, the player may change one card to a card of the same suit within two ranks (i.e., a Nine of Hearts to a Jack of Hearts). At the third level, the player may change one card to any card of the same suit within four ranks (i.e., a Ten of Spades to an Ace of Spades).

The third superpower in Example 1 is Hand Expander. At its lowest level, the example implementation of Hand Expander allows the player to receive an initial hand of six cards, discarding cards to allow replenishment to a final hand of no more than five cards. At the second level, the player may receive an initial hand of seven cards, discarding cards to allow replenishment to a final hand of no more than five cards. At the third level, the player may receive an initial hand of eight cards, discarding cards to allow replenishment to a final hand of no more than five cards.

In Example 1, superpowers may be acquired when one or more superpower icons are placed on cards to create a game-within-a-game. In particular, Chameleon icons are placed on the Two of Clubs, the Two of Spades, the Five of Spades, the Eight of Hearts, and the Ten of Diamonds. Shape Shifter icons are placed on the Two of Diamonds, the Five of Clubs, the Five of Hearts, the Eight of Spades, and the Ten of Hearts. Hand Expander icons are placed on the Two of Hearts, the Five of Diamonds, the Eight of Clubs, the Eight of Diamonds, and the Ten of Spades. The Ten of Clubs will have an SP-WILD icon, allowing it to match any other superpower icon, but the card is not wild for purposes of making a poker hand. Further, according to the embodiment of Example 1, if a player receives three of the same superpower icon in a post-draw hand, the player receives level one of that superpower. If the player receives four of the same superpower icon in a post-draw hand, the player receives level two of that power. If the player receives five of the same superpower icon in a post-draw hand, the player receives level three of that power.

As played out in Example 1, when a player receives a superpower, the superpower lasts for ten hands, beginning with the subsequent deal. Further, different superpowers may be “stacked” in that the player may possess more than one at the same time. In the embodiment of Example 1, a player may not receive more than ten deals subject to a particular superpower. However, if a player has a superpower and earns the same level of that superpower again, the player receives a “cashout bonus” compensating the player for the remaining deals of the first grant of the superpower and receives ten hands subject to the new grant of the superpower. Similarly, if a player has a number of deals remaining under level one of a superpower and earns level two of that superpower, the player receives a “cashout bonus” for the remaining level-one hands and receives ten hands with the level-two power. Finally, if a player has six deals remaining with level two of a superpower and earns level one of that superpower, the player will get six deals with level two followed by four deals of level one, plus a “cashout bonus” for the six level-one deals lost in the transaction.

According to the embodiment of Example 1, play begins with a standard electronic video poker gaming device with a touch-sensitive screen such as the video poker game screen 500 of FIG. 5 as described above. For purposes of Example 1, video poker game screen 600 of FIGS. 6A-6E is similar in form and function to video poker game screen 500. Further, in the embodiment of Example 1, a payout table 800, depicted in FIG. 8, is applied to the game. Referring to FIG. 8, payout table 800 includes hand ranks in rows 802. The columns 804 of payout table 800 define payouts for each hand rank listed in rows 802, based on the number of credits wagered, the possible wagers being spread across columns 804, of which 6 credits is the maximum wager. It should be understood that payout table 800 is only one embodiment of a payout table that may be used in the context of the present disclosure. Other payout tables known and contemplated in the art may be easily exchanged with payout table 800.

In Example 1, the player may choose from any number of variants of video poker as a base game. According to Example 1, it is assumed that the player has chosen to play Jacks or Better, with a payout table 800 set forth in FIG. 8. According to the embodiment of FIG. 8, a player may play any number of hands betting five coins or less, but would not become eligible to obtain a superpower unless the player wagers maximum coins per hand, assumed in this example to be six coins. Accordingly, in the description of Example 1 in relation to FIGS. 6A-6E, all wagers are assumed to be maximum coins per hand.

Referring to FIGS. 6A-6E, play according to Example 1 begins when the player, having sufficient credits in the machine, presses the “Deal” button on the interface or touches the “Deal” portion 644 of the touchscreen. As shown in FIG. 6A, a first hand of cards 614 is dealt in game screen area 602: card 604, Ace of Spades; card 606, Ace of Hearts; card 608, Two of Clubs, with a Chameleon icon 616; card 610, Five of Spades, with a Chameleon icon 618; and card 612, Eight of Clubs, with a Hand Expander icon 620. With first hand of cards 614, the player would have the choice (among other less desirable options) of drawing three cards to the Pair of Aces, card 604 and card 606, which guarantees the player a winning poker hand post-draw, or drawing to the two Chameleon icon cards, card 608 and card 610, in hopes of getting a third Chameleon icon card and gaining a Chameleon superpower.

As depicted in FIG. 6B of Example 1, the player keeps the two Chameleon icon cards, card 608 and card 610, discarding card 604, card 606 and card 612. FIG. 6C depicts the replacement cards received after the discard/draw. As shown in FIG. 6C, the player receives the following replacement cards: card 622, the King of Clubs; card 624, the King of Hearts; and card 626, the Ten of Clubs, with an SP-Wild icon 628.

Based on the replacement cards, and in reference to payout table 800 of FIG. 8 at payout 806, the player would receive five coins for the Pair of Kings, card 622 and card 624. In addition, according to the embodiment of Example 1, the player also receives ten subsequent deals with the Chameleon superpower, paid for through the wager, and an indication that level one of the Chameleon superpower has been acquired. Again, according to the embodiment of Example 1, because the player received three Chameleon icons, i.e. Chameleon icon 616, Chameleon icon 618 and SP-Wild icon 628, the player acquires level one of the Chameleon superpower. Accordingly, game screen area 602 provides a superpower indication 630 that the player has attained level one of the Chameleon superpower, and a deal remaining indication 632 displaying the number of deals remaining with that power.

Referring to FIG. 6D of Example 1, the player, having ten hands with the Chameleon superpower, would then recommence play. For example only, assume that the deals remaining indicator 632 indicates only 3 deals remaining, and thus, on the seventh deal of the ten hands the player is dealt seventh hand 646: card 634, Ace of Spades; card 636, King of Spades; card 638, Queen of Spades; card 640, Jack of Spades; and card 626, Ten of Clubs, with SP-Wild icon 628. Ordinarily, seventh hand 646 would be deemed a Straight, and receive the payout that most forms of video poker assign to Straights, twenty coins, as payout indicator 608 identifies in payout table 800 of FIG. 8. However, according to embodiments herein, a player empowered with level one of Chameleon can elect to change card 626, the Ten of Clubs, to card 642, the Ten of Spades, as shown in FIG. 6E. This change converts the modest Straight into the highest Straight Flush (also known as a “Royal Flush”), thereby garnering the highest payout on most forms of video poker, 4,000 coins, as payout indicator 810 identifies in payout table 800 of FIG. 8.

Accordingly, Example 1 exemplifies how game assets, such as the Chameleon superpower, may be used to significantly enhance a player's game play according to the present disclosure. The Chameleon superpower could, however, be used less dramatically to alter one card of a hand to convert a losing hand into a Flush. For example, if a player's hand contained the Three, Four, Six and Queen of Clubs, and the Nine of Spades, by converting the Nine of Spades to the Nine of Clubs, the player would be awarded a payout for a Flush.

### Example 2

According to the embodiment of Example 2, play begins with a standard electronic video poker gaming device with a touch-sensitive screen such as the video poker game screen 500 of FIG. 5 as described above. For purposes of Example 2, video poker game screen 700 of FIGS. 7A-7E is similar in form and function to video poker game screen 500. Further, in the embodiment of Example 2, payout table 800, depicted in FIG. 8, is also assumed. However, it should be understood that other payout tables known and contemplated in the art may be easily exchanged with payout table 800 for Example 2.

In Example 2, the player again may choose from any number of variants of video poker as a base game. According to Example 2, it is again assumed that the player has chosen to play Jacks or Better, with a payout table 800 set forth in FIG. 8. According to the embodiment of FIG. 8, a player may play any number of hands betting five coins or less, but would not become eligible to obtain a superpower unless the player wagers maximum coins per hand, assumed in this example to be six coins. Accordingly, in the description of Example 2 in relation to FIGS. 7A-7E, all wagers are assumed to be maximum coins per hand.

Referring to game screen area 702 of FIG. 7A, play according to Example 2 begins after a player has been playing and already simultaneously has active three superpowers. Specifically, in Example 2, play begins with level one (indicator 726) of Hand Expander, with two deals remaining (indicator 728), level two (indicator 718) of Chameleon, with four deals remaining (indicator 720), and level three (indicator 722) of Shape Shifter, with 6 deals remaining (indicator 724). The player is dealt an initial hand of six cards, hand 716, because level one of the Hand Expander power is active: card 704, Three of Spades; card 706, Four of Spades; card 708 Five of Spades, with Chameleon icon 718; card 710, Seven of Spades; card 712, Jack of Hearts; and card 714, the Ace of Diamonds.

As shown in FIG. 7B, the player decides to draw to the four Spades, cards 704, 706, 708 and 710, discarding card 712 and card 714. In FIG. 7C, the player is dealt card 730, the Nine of Hearts, as a replacement card. In usual play, this would not be a winning combination, but the player can invoke remaining superpowers. First, in FIG. 7D, the player uses the Chameleon superpower to change card 730, the Nine of Hearts, into card 732, the Nine of Spades. Because card 704, card 706, card 708, card 710 and card 732 are now all suited the same (i.e., every card is a Spade), hand 734 is a Flush, which would entitle the player to a payout of 25 coins (payout indicator 812) under paytable 800 in FIG. 8. However, using an additional superpower, the player may still improve the hand.

Referring to FIG. 7E, the player then uses level three of the Shape Shifter superpower to change card 732, the Nine of Spades, into card 736, the Six of Spades. This change results in hand 738, where card 704, card 706, card 708, card 710 and card 736 are now sequential in addition to being of the same suit, or in other words, a Straight Flush. Under payout table 800 of FIG. 8, the player would receive a payout of 250 coins (payout indicator 814), a much larger sum than the original payout of 25 (indicator 812), had no additional superpowers been applied.

While the embodiments set forth in FIGS. 6A-6E and FIGS. 7A-7E are described as being electronically implemented, the examples may also be played in a non-electronic format. For example, it is fully within the scope of the present disclosure to provide a set of gaming elements, such as the cards depicted in FIGS. 6A-6E and FIGS. 7A-7E, wherein one or more of the cards include the game asset indicators as depicted in FIGS. 6A-6E and FIGS. 7A-7E to award game assets to a player. Further, it is contemplated that one or more alternative gaming elements, such as die/dice, dominoes, roulette wheels, or other gaming elements, could also be implemented in a non-electronic format according to gaming techniques described herein.

Further, while various embodiments of the present disclosure have been described, the description is intended to be exemplary, rather than limiting, and it will be apparent to those of ordinary skill in the art that many more embodiments and implementations are possible that are within the scope of the disclosure. Accordingly, the invention is not to be restricted except in light of the attached claims and their equivalents. Also, various modifications and changes may be made within the scope of the attached claims.

What is claimed is:

1. A computer-implemented method for operating a wagering game comprising:
receiving, at a processor, a player first wager;
displaying, on a user interface, a set of plays for a first game;
determining, by the processor, whether the player has acquired a first game asset; and
updating, by the processor, a game profile for the player based on a determination that the player has acquired the first game asset, wherein the game profile for the player comprises a record of the player's current game assets; and
receiving, at a processor, a first play in the first game according to a set of rules for the first game, wherein the set of rules for the first game is based on the record of the player's current game assets.

2. The method according to claim 1, wherein the step of determining whether the player has acquired the first game asset occurs before the step of displaying the set of plays for the first game.

3. The method according to claim 1, wherein the step of determining whether the player has acquired the first game asset occurs after the step of displaying the set of plays for the first game.

4. The method according to claim 1, wherein the step of determining whether the player has acquired the first game asset occurs after the step of receiving the first play in the first game according to the set of rules for the first game.

5. The method according to claim 3, further comprising the step of determining, by the processor, that the player has acquired an initial game asset before displaying the set of plays for the first game, wherein the set of rules for the first game is based on both the initial game asset and the record of the player's current game assets.

6. The method according to claim 1, further comprising the step of determining, by the processor, that the record of the player's current game assets includes a carryover game asset, and wherein the set of rules for the first game is based on the carryover game asset.

7. The method according to claim 1, further comprising the step of determining, by the processor, a set of rules for a second game based on at least one of the carryover game asset and the first game asset.

8. The method according to claim 7, further comprising:
receiving, at a processor, a player second wager;
displaying, on a user interface, a set of plays for a second game;
determining, by the processor, whether the player has acquired a second game asset; and
adjusting, by the processor, the gaming profile for the player if the player has acquired the second game asset, and
receiving, at a processor, a first play in the second game according to the set of rules for the second game.

9. The method according to claim 3, wherein the step of determining, by the processor, whether the player has acquired a first game asset comprises determining whether the first set of plays for the first game includes at least one gaming element having a game asset indicator.

10. The method according to claim 4, wherein the step of determining, by the processor, whether the player has acquired a first game asset comprises determining whether the first set of plays for the first game includes plays of a certain value.

11. The method according to claim 1, wherein the step of determining, by the processor, whether the player has acquired a first game asset comprises determining that the player has been playing longer than a pre-determined amount of time.

12. The method according to claim 2, wherein the step of determining, by the processor, whether the player has acquired a first game asset comprises determining that the player first wager is a maximum amount.

13. The method according to claim 1, wherein the first game is a poker game.

14. A system for operating an electronic wagering game comprising:
a user interface for displaying a wagering game;
an input device for receiving plays from a player;
a memory containing wagering game instructions; and
a processor coupled to the graphical user interface, the input device, and the memory, and configured to execute the wagering game instructions comprising:
receiving, at the processor, a wager input into the input device by a player;
displaying, by the processor to the user interface, a set of plays for a first game;
receiving, at the processor, instructions input into the input device by the player, wherein the instructions include applying a game asset to the set of plays for the first game;
adjusting, by the processor, the set of plays for the first game based on the game asset applied to the set of plays for the first game; and
adjusting, by the processor, a game profile for the player based on the game asset having been applied to the set of plays for the first game.

15. The system of claim 14, wherein the set of plays for the first game includes a set of gaming elements, and wherein the game asset includes changing an attribute of at least one gaming element in the set of plays for the first game.

16. The system of claim 14, wherein the set of plays for the first game includes a set of gaming elements, and wherein the game asset includes expanding the set of plays for the first game to include at least one additional gaming element.

17. The system of claim 14, wherein the set of plays for the first game includes a set of gaming elements, and wherein the game asset includes changing a value of at least one gaming element in the set of plays for a first game.

18. The system of claim 17, wherein changing the value of at least one gaming element in the set of plays for the first game includes changing the value of the at least one gaming element to an adjacent value.

19. The system of claim 14, wherein the processor is configured to execute wagering game instructions further comprising:
prior to receiving a wager by a player, receiving, at the processor, instructions input into the input device by the player, wherein the instructions include applying an initial game asset to the first game, and wherein the initial game asset changes a payout table to be applied to the first game.

20. A non-transitory computer-readable medium comprising computer-readable instructions for performing steps in a wagering game comprising:
receiving, from an input device, a wager;
displaying, to a user interface, a set of plays for a first game;
receiving, from the input device, instructions for applying a game asset to the set of plays for the first game;
displaying, to a user interface, an adjusted set of plays for the first game based on the game asset applied to the set of plays for the first game; and
returning, to the user interface, a payout for the adjusted set of plays for the first game.

21. The non-transitory computer-readable medium of claim 20, further comprising instructions for, prior to receiving the wager, receiving, from the input device, instructions for applying an initial game asset to the first game.

22. The non-transitory computer-readable medium of claim 21, wherein the initial game asset changes a payout table to be applied to the first game.

23. The non-transitory computer-readable medium of claim 20, further comprising instructions for determining, based on the set of plays for the first game, whether the player has acquired a new game asset.

24. A game comprising:
a plurality of gaming elements, wherein each of the plurality of gaming elements includes a value and comprises a potential play in a wagering game, and wherein:
a subset of the plurality of gaming elements further includes at least one game asset indicator; and
the at least one game asset indicator gives the player the ability to change an outcome of at least one of the plurality of gaming elements during play.

25. The game according to claim 24, wherein the at least one game asset indicator gives the player the ability to change a set of game rules during play.

26. The game according to claim 24, wherein each of the subset of the plurality of gaming elements comprises at least one of a plurality of game asset indicators.
